(19) United States
(12) Patent Application Publication
(10) Pub. No.: US 2002/0056955 A1
(43) Pub. Date: May 16, 2002

(54) Machine tool vise jaw assembly and method for using same

(76) Inventor: Steven T. Klabo, San Jose, CA (US)

Correspondence Address: Eric A. Dippel, 3557 Amber Drive, San Jose, CA, 95117, US

(21) Appl. No.: 10/003,167

(22) Filed: Nov. 14, 2001

Related U.S. Application Data
(60) Provisional application No. 60/248,818, filed on Nov. 14, 2000.

(51) Int. Cl. B25B 5/16

(52) U.S. Cl. 269/257

(57) ABSTRACT

A vise jaw provides improved workpiece holding capabilities. The vise jaw utilizes a series of gripping pads located laterally along the jaw. When tightened by the vise, the gripping pads on the jaw introduce a horizontal force on the workpiece, causing them to penetrate and gouge the workpiece. The vise jaw is thereby designed to provide increased retention capabilities against a precision supporting surface. The workpiece will remain in place during the machining process regardless of the shape of the workpiece or the direction of the machine tool operation force.

### CROSS REFERENCE TO RELATED APPLICATIONS

This application claims the benefit of U.S. Provisional Application Ser. No. 60/248,818, filed Nov. 14, 2000, entitled “Jaw Assembly For Use In A Machine Tool Vise”, which is hereby incorporated by reference.

### BACKGROUND OF THE INVENTION

1. Field of the Invention

The present invention relates generally to machine tools, and more particularly to an apparatus and method for setting up and securing a workpiece to a machine tool while performing various tooling operations thereon, such as boring, shaving, grinding, drilling and the like.

2. Description of the Related Art

The manufacturing industry requires many mechanical operations be performed on a single workpiece by a machine tool in order to develop the workpiece into a finished part. A workpiece must often be molded, cut, drilled, and ground to precise finished tolerances according to a specification. Machine tool operations require that the workpiece be positioned in a precise and secure manner, disposed horizontally, vertically or angularly, to a machine tool base for subsequent machining.

It is well known in machining operations to support a workpiece in a vise or other part holder. Various designs of vises and vise jaws are used for this purpose. The workpiece might be secured by way of hard jaws, usually made of flat heat-treated steel, with parallels. Alternatively, the workpiece might be held in place using soft jaws, usually made of aluminum, which include a milled step. The workpiece can be secured tightly between the parallels of the vise, or can be placed on the flat step of the jaws and tightened in place for precision machining.

However, using standard hard jaws with parallels and soft jaws with steps have proven ineffective in many cases. For example, in the case of a machining operation where the machine tool exerts a force transverse to the clamping force of the vise jaws, the workpiece will tend to shift or change its position relative to the machine tool. This can also occur where the workpiece extends substantially above the horizontal plane of the vise jaws and the machining operation is applied in a direction that is parallel to the clamping force of the jaws, thereby exerting a cantilevered force on the workpiece. The torque thus applied to the workpiece by the machine tool will likewise cause unwanted shifting or movement of the workpiece. This makes it difficult, if not impossible, to maintain rigid manufacturing tolerances on certain parts.

For all of the foregoing reasons, an apparatus and method are needed in the manufacturing industry to provide an effective means to secure a workpiece to a machine tool vise to prevent movement or shifting of the workpiece relative to the machine no matter what operational forces are applied.

### SUMMARY OF THE INVENTION

The vise jaw of the present invention provides an improved workpiece holding assembly. The vise jaw utilizes a series of gripping pads located along the long edge of the jaw. When tightened by the vise, the gripping pads on the jaw introduce a horizontal force on the workpiece. Because the material from which the gripping pad is made is harder than that of the workpiece, the gripping pads will penetrate and gouge the workpiece as the horizontal force on the workpiece from the vise increases. The vise jaw is thereby designed to provide increased retention capabilities against a precision supporting surface. The workpiece will remain in place during the machining process regardless of the shape of the workpiece or the direction of the machine tool operational force. The vise jaw can be designed with varying step heights that can be adjusted to accommodate workpieces of varying dimensions.

### BRIEF DESCRIPTION OF THE DRAWINGS

FIG. 1 shows a side elevation view of a vise jaw assembly coupled to a machine tool vise in accordance with the principles of the present invention.

FIG. 2 shows a side cross sectional view of a vise jaw of the present invention.

FIG. 3 shows a top plan view of the vise jaw of the present invention.

FIG. 4 shows a front elevation view of the vise jaw of the present invention.

FIG. 5 shows a detailed front view of gripping pads and notches of the present invention.

FIG. 6 shows the use of the vise jaw assembly on a workpiece according to the principles of the present invention.

### DETAILED DESCRIPTION OF THE INVENTION

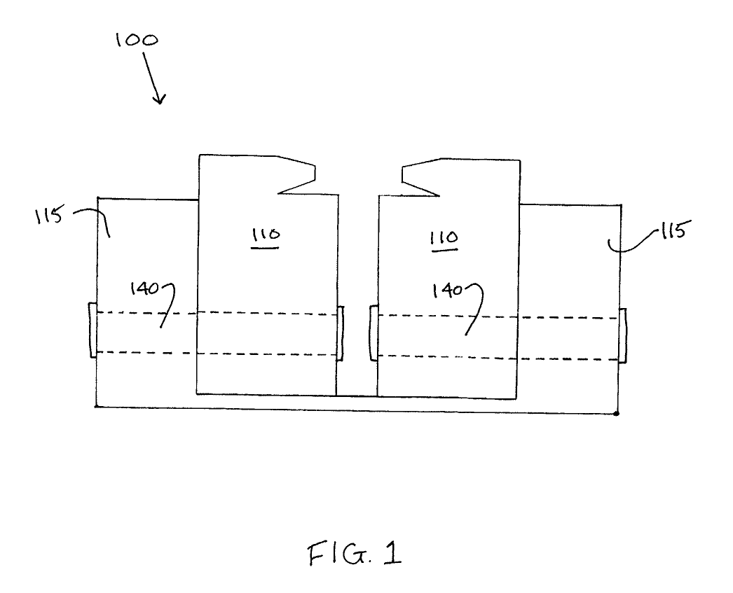

FIG. 1 depicts a schematic of a side elevation view of one aspect of a vise assembly 100 of the present invention. As can be seen, the vise assembly 100 consists of a pair of matching vise jaws 110. The vise jaws 110 of the vise assembly 100 are placed on a standard machine tool vise 115. Each vise jaw 110 contains a means to couple the vise jaw to the machine tool vise 115. In one aspect of the invention, each vise jaw 110 contains one or more attachment openings 140, through which standard clamping or bolting means are used to secure the vise jaws 110 to the machine tool vise 115. Once securely coupled to the machine tool vise 115 in this way, the vise jaws 110 are parallel and opposite to each other in the machine tool vise.

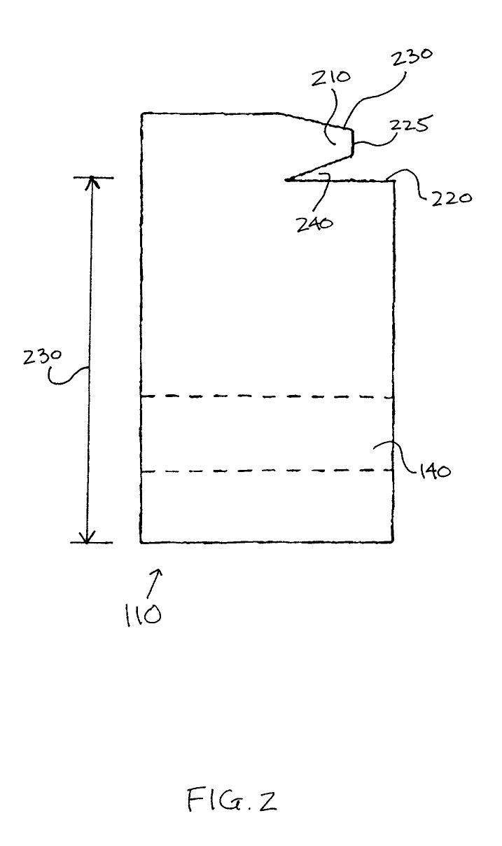

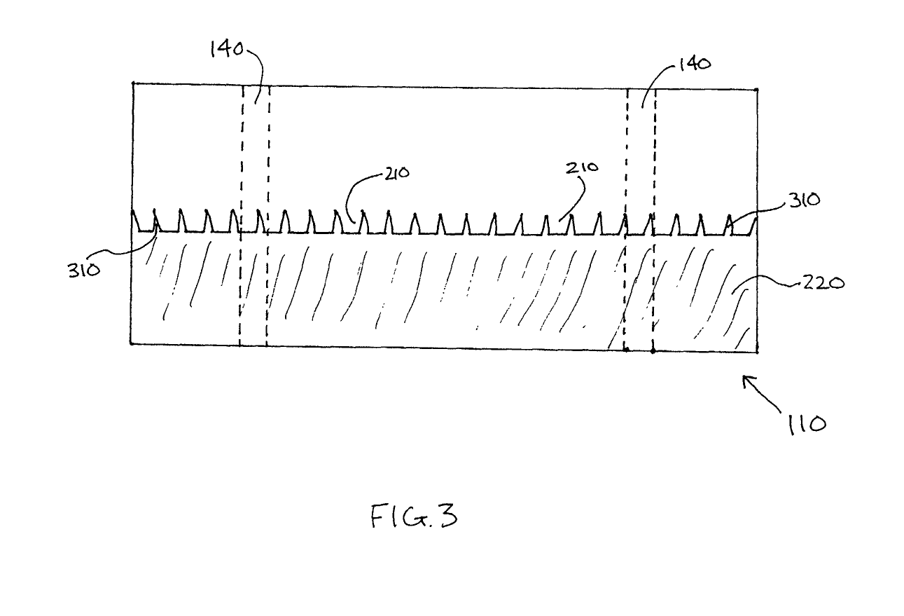

FIG. 2 shows a detailed side elevation view of a cross section of the vise jaw 110. As can be seen, the vise jaw 110 contains one or more attachment openings 140 discussed above in reference to FIG. 1. The cross section of vise jaw 110 is preferably L-shaped and comprises a plurality of gripping pads 210, which are disposed laterally along the length of the vise jaw (discussed in more detail below with respect to FIG. 3). The vise jaw 110 also includes a vertical clamping surface 225 and a contact surface 220. In one aspect of the invention, the contact surface 220 of the vise jaw 110 is a flat, milled surface that runs the length of the vise jaw (discussed in more detail below with respect to FIG. 3). The distance between the contact surface 220 and the bottom of the vise jaw 110 is shown as a step height 230. In manufacturing the vise jaw 110, the step height 230 is adjusted to accommodate workpieces of varying dimensions. For example, a workpiece with a relatively large vertical dimension would require a smaller step height 230, while a workpiece with a relatively shorter vertical dimension would require a larger step height 230. The gripping pad 210 protrudes horizontally and is perpendicular to the contact surface 220. The cross section of the gripping pad 210 is characterized by a relief cut 240 on the bottom of the gripping pad and a chamfered surface 230 at the top of the gripping pad. As discussed above with reference to FIG. 1, a pair of vise jaws 110 is used to form the vise assembly 100; therefore, the vise jaw 110 shown and described in FIG. 2, depicted as a left side vise jaw, is a mirror image of and identical to the companion right side vise jaw of the vise assembly 100.

FIG. 3 depicts a top view of the vise jaw 110. As discussed above with reference to FIG. 2, the vise jaw 110 comprises a plurality of gripping pads 210 disposed linearly along the length of the vise jaw at predetermined and regularly spaced intervals. Each gripping pad 210 is separated from each adjoining gripping pad by a notch 310. Each notch 310 can be milled into the vise jaw 110 at various widths and intervals in order to accommodate workpieces of varying shapes, sizes and hardness. The contact surface 220 is preferably flat. The attachment opening 140 passes through the width of the vise jaw 110.

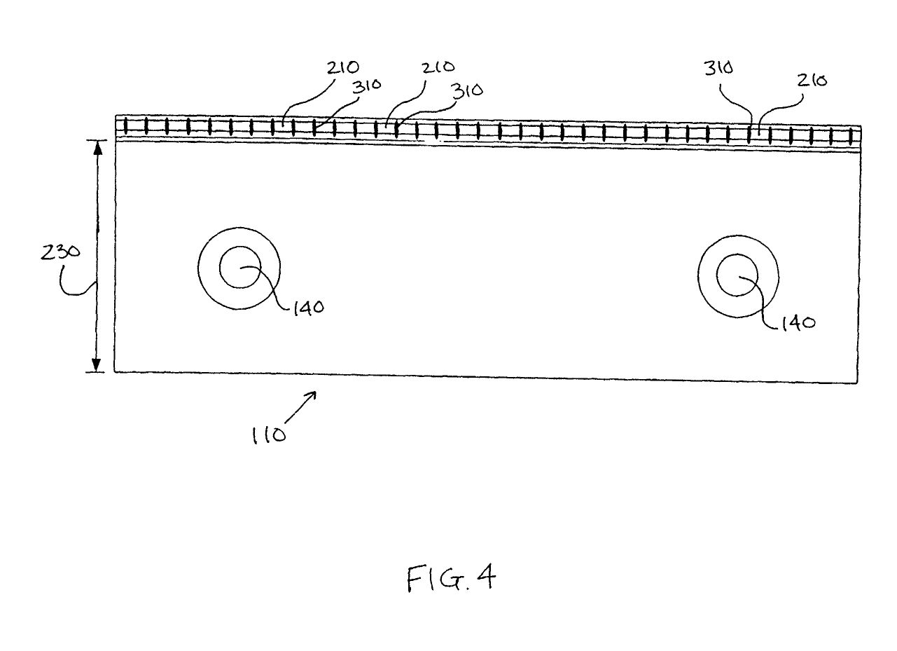

FIG. 4 shows a front elevation view of the vise jaw 110. As discussed above with reference to FIGS. 2 and 3, the vise jaw 110 comprises a plurality of gripping pads 210 disposed linearly along the length of the vise jaw at predetermined and regularly spaced intervals. As can be seen, notches 310 separate each gripping pad 210, and the attachment openings 140 are present to couple the vise jaw 110 to the machine tool vise 115 (not shown).

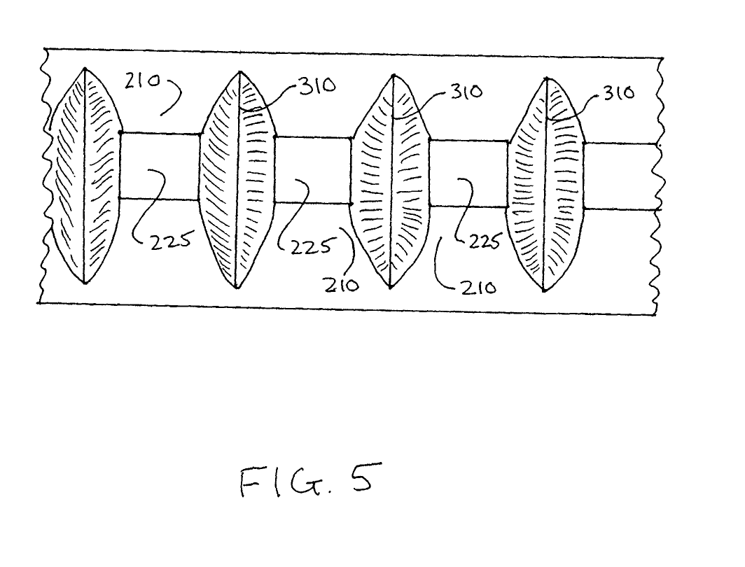

FIG. 5 depicts a detailed front view of the gripping pads 210, the vertical clamping surface 225 and the notches 310. As can be seen, the notches 310 are milled into the surface of the vise jaw 110, creating a space between each gripping pad 210. The vertical clamping surface 225 is disposed on the front of each gripping pad 210.

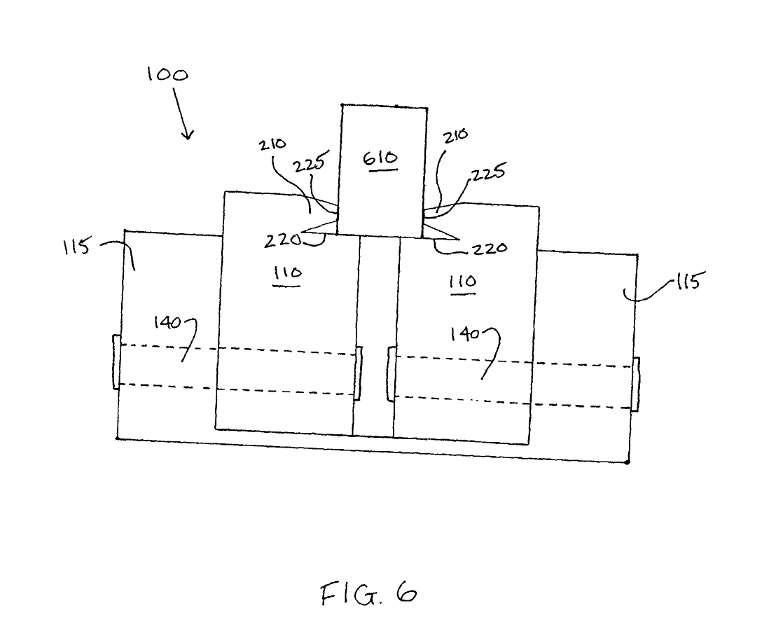

FIG. 6 shows how the vise assembly 100 of the present invention provides a means to securely grip workpieces during machine tool operations. First, a pair of vise jaws 110 is placed onto the left and right side of the machine tool vise 115. A coupling means, such as a clamp or bolt, is inserted through the attachment openings 140 of the vise jaws 110 and tightened to secure the vise jaws to the machine tool vise. Next, a workpiece 610 is placed on the contact surface 220 of the left and right vise jaws 110. The machine tool vise 115 is then tightened. As the vise jaws 110 move closer to each other, the vertical clamping surfaces 225 of each vise jaw eventually come into contact with the workpiece 610. As long as the material hardness of the gripping pads 210 is greater than that of the workpiece 610, further tightening of the machine tool vise 115 will cause the gripping pads to penetrate and deform the outer surface of the workpiece. The gripping pads 210 will thereby gouge the workpiece 610 a certain amount. This gouging action of the gripping pads 210 into the workpiece 610 supplies a secure and efficient grip on the workpiece. Thus, regardless of the orientation or direction of the force applied to the workpiece by the machine tool, the vise jaws 110 will not allow the workpiece to move or shift in any direction during the machining process.

In order for the gouging and subsequent gripping action to occur, the hardness of the gripping pads 210 must be greater than that of the workpiece 610. Therefore, in one aspect of the invention, the gripping pads 210 are made from tool steel. This provides the gripping pads 210 with a hardness greater than that of many machinable materials.

Once the machining process on the workpiece 610 is completed, the machine tool vise 115 is loosened. As the left and right vise jaws 110 move away from each other, the gripping pads 210 loosen their grip on the workpiece 610, and the workpiece can then be removed from the vise assembly 100. A portion of the workpiece 610 may contain marks and gouges at the point where the gripping pads 110 engaged the workpiece. This section of the workpiece may be milled or cut off, if desired, so as not to include it as part of the finished workpiece.

While the present invention has been described in detail by specific reference to preferred aspects, it is understood that the above description is not limiting of the disclosed invention and variations and modifications thereof may be made without departing from the true spirit and scope of the invention.

I claim:

1. A machine tool vise jaw for securing a workpiece, comprising:
a contact surface upon which the workpiece rests;
a gripping surface; and
a plurality of gripping pads disposed longitudinally along the gripping surface.

2. The machine tool vise jaw of claim 1 wherein the hardness of the gripping pad is greater than that of the workpiece.

3. The machine tool vise jaw of claim 1 wherein the gripping pad is made from tool steel.

4. The machine tool vise jaw of claim 1 further comprising a means for coupling the vise jaw to a machine tool vise.

5. The machine tool vise jaw of claim 1 wherein the gripping pads are defined by notches disposed between each gripping pad.

6. A machine tool vise assembly, comprising:
a machine tool vise;
a pair of vise jaws, each coupled to one side of the machine tool vise, each vise jaw including,
a contact surface upon which a workpiece rests;
a gripping surface; and
a plurality of gripping pads disposed longitudinally along the gripping surface.

7. The machine tool vise assembly of claim 6 wherein the hardness of the gripping pad is greater than that of the workpiece.

8. The machine tool vise jaw of claim 6 wherein the gripping pad is made from tool steel.

9. The machine tool vise assembly of claim 6 further comprising a means for coupling the vise jaw to a machine tool vise.

10. The machine tool vise assembly of claim 6 wherein the gripping pads are defined by notches disposed between each gripping pad.

11. A method for securing a workpiece in a machine tool vise, comprising the steps of:
providing a pair of vise jaws coupled to each side of the machine tool vise, the vise jaws including,
a contact surface upon which the workpiece rests,
a gripping surface, and
a plurality of gripping pads disposed longitudinally along the gripping surface; and
penetrating the surface of the workpiece with the gripping pads to provide a secure grip on the workpiece.

12. The method of claim 11 wherein the hardness of the gripping pad is greater than that of the workpiece.

13. The method of claim 11 wherein the gripping pad is made from tool steel.

14. The method of claim 11 wherein the gripping pads are defined by notches disposed between each gripping pad.
